(19) United States
(12) Patent Application Publication
(10) Pub. No.: US 2007/0188413 A1
(43) Pub. Date: Aug. 16, 2007

(54) Plasma display device

(76) Inventors: Isao Furukawa, Tama (JP); Makoto Onozawa, Yokohama (JP); Yasunobu Hashimoto, Kawasaki (JP); Tomokatsu Kishi, Yokosuka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/704,367

(22) Filed: Feb. 9, 2007

(30) Foreign Application Priority Data
Feb. 10, 2006 (JP) 2006-034222

(51) Int. Cl. G09G 3/28

(52) U.S. Cl. 345/67

(57) ABSTRACT

A plasma display device, including a first substrate and a second substrate opposed to each other, a first electrode and a second electrode arranged in parallel on one of the first and second substrates so as to enable a generation of a display discharge therebetween and a chassis which supports at least one of the first and second substrates. The first electrode is connected to the chassis without an interposition of a circuit for controlling the first electrode and is maintained at a constant potential.

### CROSS-REFERENCE TO RELATED APPLICATIONS

This application is based upon and claims the benefit of priority from the prior Japanese Patent Application No. 2006-034222, filed on Feb. 10, 2006, the entire contents of which are incorporated herein by reference.

### BACKGROUND OF THE INVENTION

1. Field of the Invention

The present invention relates to a plasma display device.

2. Description of the Related Art

Conventionally, both X electrode and Y electrode have been connected to a chassis having a potential at a ground level via an X electrode driving circuit substrate and a Y electrode driving circuit substrate for the purpose of applying discharge voltage (drive waveform).

A driving method to fix the X electrode at a fixed potential has been already devised as described in Japanese Patent Application Laid-open No. 2005-309397), but connection of the X electrode to fix the X electrode to a ground as a fixed potential has not been considered.

When a ground is taken as a fixed potential, the X electrode can be connected to a chassis because it gets the same potential (ground) as that of the chassis. However, when the X electrode is connected to the chassis via the X electrode driving circuit substrate and a flexible printed circuit (FPC) substrate similarly to the conventional manner, it may not only increase the costs for the panel, but also creates a problem that a ground potential cannot be maintained in a fixed level due to impedance of the X electrode driving circuit substrate.

### SUMMARY OF THE INVENTION

An object of the present invention is to provide a plasma display device which makes it possible to lower the impedance between a panel electrode (X electrode or Y electrode) and a chassis to maintain a ground potential constant and to realize the cost reduction.

A plasma display device of the present invention includes a first substrate and a second substrate opposed to each other, a first electrode and a second electrode arranged in parallel on one of the first and second substrates so as to enable a generation of a display discharge therebetween and a chassis which supports at least one of the first and second substrates. The first electrode is connected to the chassis without interposition of a circuit for controlling the first electrode and is maintained at a constant potential.

### BRIEF DESCRIPTION OF THE DRAWINGS

FIG. 1 is a view showing a structural example of a plasma display device according to a first embodiment of the present invention;

FIG. 2 is a timing chart to explain operation examples during a reset period, an address period, and a sustaining period according to the present embodiment;

FIG. 3 is a cross section showing a structural example of the plasma display device according to the present embodiment;

FIG. 4 is a cross section showing a structural example of the plasma display device according to a second embodiment;

FIG. 5 is a cross section showing a structural example of the plasma display device according to a third embodiment;

FIG. 6 is a cross section showing a structural example of the plasma display device according to a fifth embodiment;

FIG. 7 is a perspective view showing a structural example of the plasma display device according to a sixth embodiment;

FIG. 8 is a view showing a structural example of a conductor according to a seventh embodiment;

FIG. 9 is a view showing a structural example of the plasma display device according to an eighth embodiment;

FIG. 10 is a view showing a structural example of the plasma display device according to a ninth embodiment;

FIG. 11 is a view showing a structural example of the plasma display device;

FIG. 12 is an exploded perspective view showing a structural example of the plasma display panel;

FIG. 13 is a timing chart to explain operation examples during a reset period, an address period, and a sustaining period;

FIG. 14 is a cross section showing a structural example of the plasma display device; and

FIG. 15 is a cross section showing a structural example of the plasma display device according to a fourth embodiment.

### DETAILED DESCRIPTION OF THE PREFERRED EMBODIMENTS

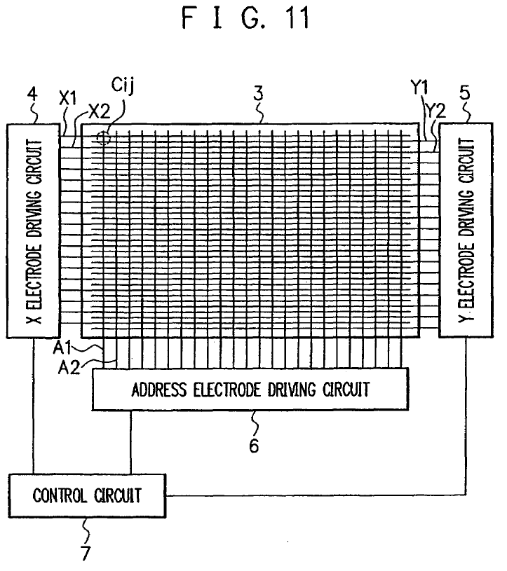

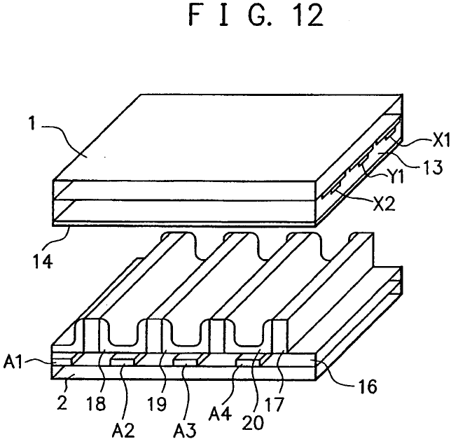

FIG. 11 is view showing a structural example of a plasma display device. A control circuit 7 controls an X electrode driving circuit 4, a Y electrode driving circuit 5, and an address electrode driving circuit 6. The X electrode driving circuit 4 supplies a prescribed voltage to a plurality of X (sustain) electrodes X1, X2, . . . . Hereinafter, each of the X electrodes X1, X2, . . . , or the general term thereof is referred to as an X electrode Xi, and i means the subscript thereof. The Y electrode driving circuit 5 supplies a prescribed voltage to a plurality of Y (scan) electrodes Y1, Y2, . . . . Hereinafter, each of the Y electrodes Y1, Y2, . . . , or the general term thereof is referred to as a Y electrode Yi, and i means the subscript thereof. The address electrode driving circuit 6 supplies a prescribed voltage to a plurality of address electrodes A1, A2, . . . . Hereinafter, each of the address electrodes A1, A2, . . . , or the general term thereof is referred to as an address electrode Aj, and j means the subscript thereof. Here, the Y electrode driving circuit 5 controls a voltage applied to the Y electrode Yi whereas the X electrode driving circuit 4 controls a voltage applied to the X electrode Xi, to generate a discharge display during a sustain period. The address electrode driving circuit 6 controls a voltage applied to the address electrode Aj and to generate a address discharge between an address electrode Aj and an corresponding scan electrode during an address period.

In a plasma display panel 3, the Y electrode Yi and the X electrode Xi form rows extending in parallel in the horizontal direction, and the address electrode Aj forms columns extending vertically. The Y electrode Yi and the X electrode Xi are arranged alternately in the vertical direction. The Y electrode Yi and the address electrode Aj form a two dimensional matrix in i rows and j columns. A display cells Cij includes an intersection point of the Y electrode Yi and the address electrode Aj, and an intersection point of the adjacent X electrode Xi and the address electrode Aj. The display cell Cij corresponds to a pixel and the plasma display panel 3 can display a two-dimensional image.

FIG. 12 is an exploded perspective view showing a structural example of the plasma display panel 3. The X electrode Xi and the Y electrode Yi are formed in parallel on a front glass substrate 1, extending in a horizontal direction. A dielectric layer 13 is formed further thereon to insulate against a discharge space. An MgO (magnesium oxide) protective layer 14 is formed further thereon. Meanwhile, the address electrode Aj is formed on a back glass substrate 2 disposed facing to the front glass substrate 1, extending in a vertical direction. In a dielectric layer 16 is formed thereon. Phosphor 18 to 20 is covered further thereon. In the inside surface of a partition 17, red, blue, and green phosphor 18 to 20 are arranged and colored in a striped shape for each color. The phosphor 18 to 20 are excited by ultra-violet ray generated by a discharge between the X electrode Xi and the Y electrode Yi, and the respective colors emit light. In a discharge space between the front glass substrate 1 and the back glass substrate 2, a neon and xenon (Ne+Xe) Penning gas or the like is filled.

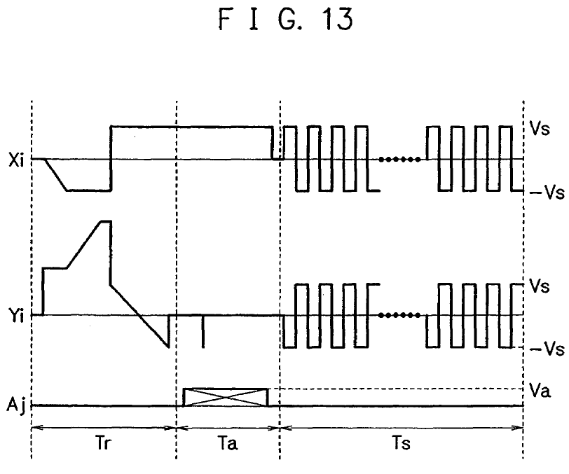

FIG. 13 is a timing chart to explain operation examples during a reset period Tr, an address period Ta, and a sustaining period Ts.

During the reset period Tr, a prescribed voltage is applied to the X electrode Xi and the Y electrode Yi to perform initialization of the display cell Cij.

During the address period Ta, by applying a scan pulse to the Y electrode Y1, Y2, . . . through sequential scanning, and by applying an address pulse to the address electrodes Aj, corresponding to the scan pulse, a display pixel is selected. When an address pulse of the address electrode Aj is generated corresponding to the scan pulse of the Y electrode Yi, a display cell of the Y electrode Yi and the X electrode Xi is selected. When an address pulse of the address electrode Aj is not generated corresponding to the scan pulse of the Y electrode Yi, the display cell of the Y electrode Yi and the X electrode Xi is not selected. When an address pulse is generated is corresponding to the scan pulse, an address discharge occurs between the address electrode Aj and the Y electrode Yi, which causes an electric discharge between the X electrode Xi and the Y electrode Yi using the address discharge as a pilot burner, a negative charge is accumulated on the X electrode Xi, and a positive charge is accumulated on the Y electrode Yi.

During the sustaining period Ts, a sustaining pulse is applied between the X electrode Xi and the Y electrode Yi in a reverse phase to each other, to perform sustaining discharge between the X electrode Xi and the Y electrode Yi of the selected display cell so as to emit light.

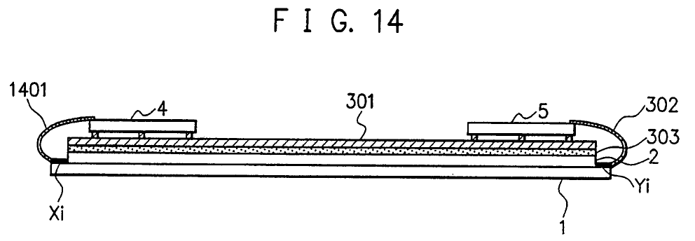

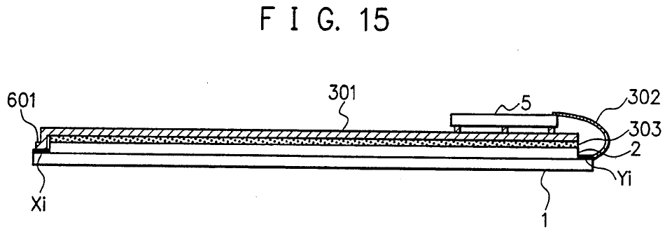

FIG. 14 is a cross section showing a structural example of the plasma display device. As described above, the plasma display panel 3 includes the front glass substrate 1 and the back glass substrate 2. The back glass substrate 2 is adhered to a chassis 301 via an adhesive 303. The chassis 301 supports the back substrate 2, in other words, the plasma display panel 3. The X electrode driving circuit 4 and the Y electrode driving circuit 5 are provided on the back face of the chassis 301. A plurality of the X electrodes Xi and a plurality of the Y electrodes Yi are provided on the front glass substrate 1. A plurality of the X electrodes Xi are connected to the X electrode driving circuit 4 via a FPC 1401. A ground of the X electrode driving circuit 4 is connected to the chassis 301. A plurality of the Y electrodes Yi are connected to the Y electrode driving circuit 5 via a FPC 302. A ground of the Y electrode driving circuit 5 is connected to the chassis 301.

### First Embodiment

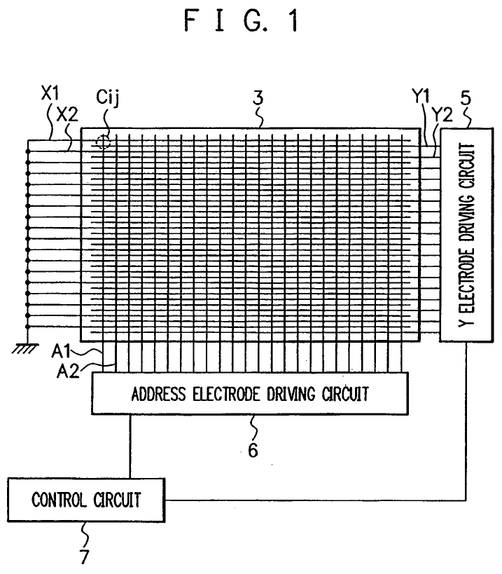

FIG. 1 is a view showing a structural example of a plasma display device according to the first embodiment of the present invention. Hereinafter, the points of the present embodiment different from that in FIG. 11 will be explained. In the present embodiment, the X electrode driving circuit 4 shown in FIG. 11 is eliminated. All of the X electrodes Xi are connected to a ground potential. Other points in the present embodiment are the same as those in FIG. 11. According to the present embodiment, since the X electrode driving circuit 4 can be eliminated from FIG. 11, the costs of the plasma display device can be reduced.

The structure of the plasma display panel 3 of the present embodiment is the same as that in FIG. 12. In other words, the plasma display panel 3 includes the front glass substrate 1 and the back glass substrate 2. The front glass substrate 1 includes a plurality of X electrodes Xi and a plurality of Y electrodes Yi. The back glass substrate 2 includes a plurality of address electrodes Aj intersecting a plurality of X electrodes Xi and Y electrodes Yi. Here, the Y electrode driving circuit 5 controls a voltage applied to the Y electrode Yi. However, since the X electrode driving circuit 4 described in FIG. 11 is eliminated, the voltage applied to X electrode to generate a display discharge is not controlled by a driving circuit.

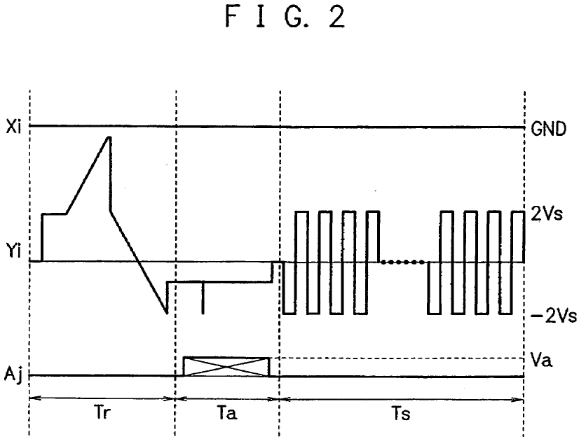

FIG. 2 is a timing chart to explain operation examples of a reset period Tr, an address period Ta, and a sustaining period Ts according to the present embodiment. All of the X electrodes Xi are fixed to a ground potential. The potential difference between the X electrode Xi and the Y electrode Yi is the same as that in FIG. 13. The operations during the reset period Tr, the address period Ta and the sustaining period Ts are the same as those explained in the above-described FIG. 13.

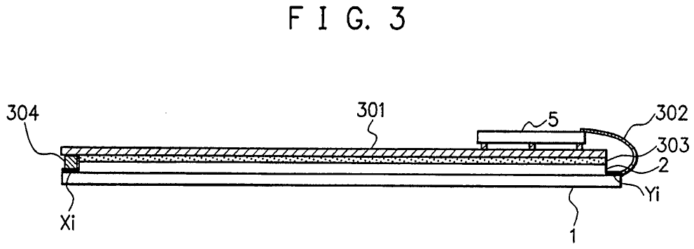

FIG. 3 is a cross section showing a structural example of the plasma display device according to the present embodiment. In the present embodiment, the X electrode driving circuit 4 and the FPC 1401 in FIG. 14 are eliminated. All of the X electrodes Xi on the front glass substrate 1 are connected to the chassis 301 via a conductor 304 as a fixed potential at a ground level. The conductor 304 is, for instance, metal, a conductive resin, a conductive tape, or the like, and sandwiched between the front glass substrate 1 and the chassis 301. The back glass substrate 2 is provided so as to be sandwiched between the front glass substrate 1 and the chassis 301. The end portion of the chassis 301 is extended more than that the back glass substrate 2, so as to connect to the X electrode Xi on the front glass substrate 1. The thickness of the conductor 304 is designed to be thicker than the interval between the front glass substrate 1 and the chassis 301. The conductor 304 and all of the X electrodes Xi are connected using a conductive adhesive, and the conductor 304 and the chassis 301 are connected using a conductive adhesive.

Here, a ground corresponds to a reference potential for driving the plasma display panel 3, and equivalent to the chassis 301 in potential. Since there is no need for the X electrode Xi to apply a discharge pulse, the X electrode driving circuit 4 becomes unnecessary, and the plasma display panel 3 can be driven by fixedly connecting the X electrode Xi and the chassis 301.

The plasma display panel 3 comprises the front glass substrate 1 and the back glass substrate 2. The back glass substrate 2 is adhered to the chassis 301 through the adhesive 303. The chassis 301 supports the plasma display panel 3. The Y electrode driving circuit 5 is provided on the back of the chassis 301. On the front glass substrate 1, a plurality of the X electrode Xi and a plurality of the Y electrode Yi are provided. A plurality of the Y electrode Yi are connected to the Y electrode driving circuit 5 via the FPC 302. The Y electrode driving circuit 5 applies a discharge voltage (discharge pulse) to the Y electrode Yi. A ground of the Y electrode driving circuit 5 is connected to the chassis 301.

It is possible to realize cost reduction because the X electrode driving circuit 4 and the FPC 1401 are eliminated in the present embodiment, compared with the plasma display device in FIG. 14. Here, the Y electrode Yi is connected to the chassis via the Y electrode driving circuit 5, X electrode Xi is connected to the chassis without such a driving circuit. Since the X electrode Xi is connected to the chassis 301 without the FPC 1401 and the X electrode driving circuit 4 as a fixed potential at a ground level, it is possible to connect it to the chassis 301 in a short distance, which can lower impedance between the X electrode Xi and the chassis 301. In other words, the X electrode Xi is connected to the chassis 301 without interposition of a circuit for controlling the X electrode Xi and is maintained at a constant potential. The X electrode Xi can be directly connected the chassis 301. Further, the constant potential can be fixed at a predetermined potential, such as a ground level. Accordingly, it becomes possible to keep the ground potential constant.

As described above, the X electrode Xi is connected to the chassis 301 using a conductor (metal, a conductive resin, a conductive tape, etc.) 304 in the present embodiment. In FIG. 14, the chassis 301 has nearly the same length as the back glass substrate 2. In the present embodiment (FIG. 3), the chassis 301 is extended to be the same length as the front glass substrate 1, and is connected to the X electrode Xi, using the conductor 304. Since the X electrode Xi and the chassis 301 are connected at the shortest distance, it is possible to lower impedance compared with the case of connecting the X electrode Xi to the chassis 301 via the FPC 1401 and the X electrode driving circuit 4 in FIG. 14, and to reduce the costs. Furthermore, by using a conductive adhesive, it is possible to connect the conductor 304 and the X electrode Xi, and the conductor 304 and the chassis 301, more securely. It doesn't matter whether connection of the X electrode Xi and the chassis 301 with all of the plasma display panel 3, or with a portion of the plasma display panel 3.

### Second Embodiment

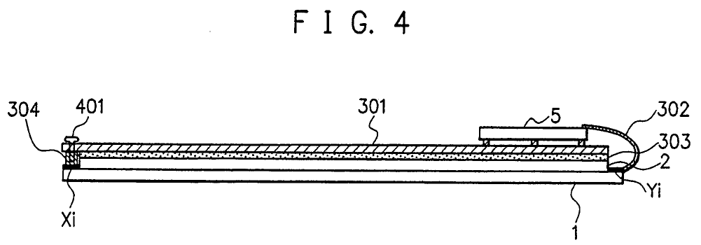

FIG. 4 is a cross section showing a structural example of the plasma display device according to the second embodiment of the present embodiment. The present embodiment is carried out while adding screws 401 to the first embodiment (FIG. 3). The conductor 304 is connected to the chassis 301 with the screws 401. Other points in the present embodiment are the same as those in the first embodiment.

### Third Embodiment

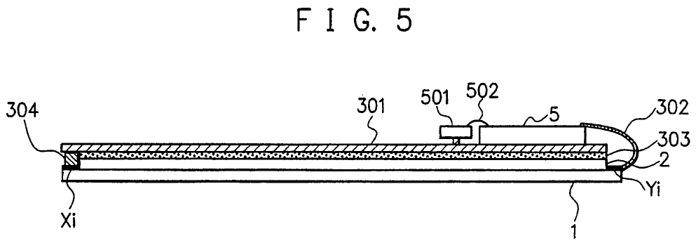

FIG. 5 is a cross section showing a structural example of the plasma display device according to the third embodiment of the present invention. The present embodiment is carried out while adding a circuit substrate 501 to the first embodiment (FIG. 3). A ground of the circuit substrate 501 is connected to the chassis 301. A ground of the Y electrode driving circuit 5 is connected to a ground of the circuit substrate 501 via wiring 502. A ground of the Y electrode driving circuit 5 is not directly connected to the chassis 301, but is connected to the chassis 301 via a circuit substrate 501 different from the substrate of the Y electrode driving circuit 5. Other points in the present embodiment are the same as those in the first embodiment.

### Fourth Embodiment

FIG. 15 is a cross section showing a structural example of the plasma display device according to the fourth embodiment of the present invention. The present embodiment is carried out while canceling the conductor 304 from the first embodiment (FIG. 3). An end portion 601 of the chassis 301 is bent toward the front glass substrate 1 to connect to the X electrode Xi of the front glass substrate 1. All of the X electrodes Xi are directly connected to the end portion 601 of the chassis 301 as a fixed potential at a ground level. Other points in the present embodiment are the same as those in the first embodiment.

In addition, the present embodiment may provide the circuit substrate 501 as in the third embodiment (FIG. 5). In other words, it is possible that a ground of the Y electrode driving circuit 5 is not directly connected to the chassis 301, but is connected via the circuit substrate 501 different from the substrate of the Y electrode driving circuit 5, to the chassis 301.

As described above, in the present embodiment, the end portion 601 of the chassis 301 is bent toward the X electrode Xi side of the front glass substrate 1 to perform connection. It is possible to eliminate the conductor 304 from the first embodiment (FIG. 3) by bending the end portion 601 of the chassis 301 toward the X electrode Xi side so as to reduce the costs. The end portion 601 of the chassis 301 can be bent using a press machine or the like.

### Fifth Embodiment

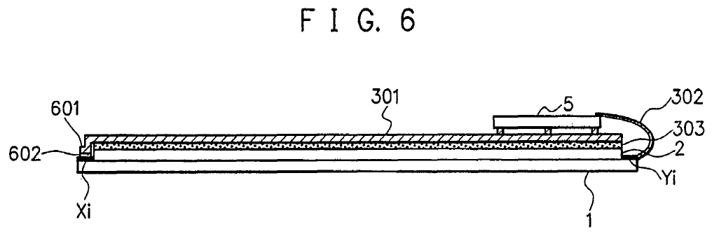

FIG. 6 is a cross section showing a structural example of the plasma display device according to the fifth embodiment of the present invention. The present embodiment is carried out while adding a conductor 602 to the fourth embodiment (FIG. 15). The end portion 601 of the chassis 301 is bent in the direction of the front glass substrate 1, to connect to the X electrode Xi on the front glass substrate 1. All of the X electrodes Xi are connected to the end portion 601 of the chassis 301 via the conductor 602 as a fixed potential at a ground level. The conductor 602 is, for instance, metal, a conductive resin, a conductive tape, or the like, and is sandwiched between the front glass substrate 1 and the chassis 301. Other points in the present embodiment are the same as those in the first embodiment.

As described above, in the present embodiment, the end portion 601 of the chassis 301 is bent toward the X electrode Xi side of the front glass substrate 1 to perform connection. It is possible to reduce the amount to be used of the conductor 602, compared with the first embodiment (FIG. 3) by bending the end portion 601 of the chassis 301 toward the X electrode Xi side, so as to reduce the costs. The end portion 601 of the chassis 301 can be bent using a press machine or the like.

### Sixth Embodiment

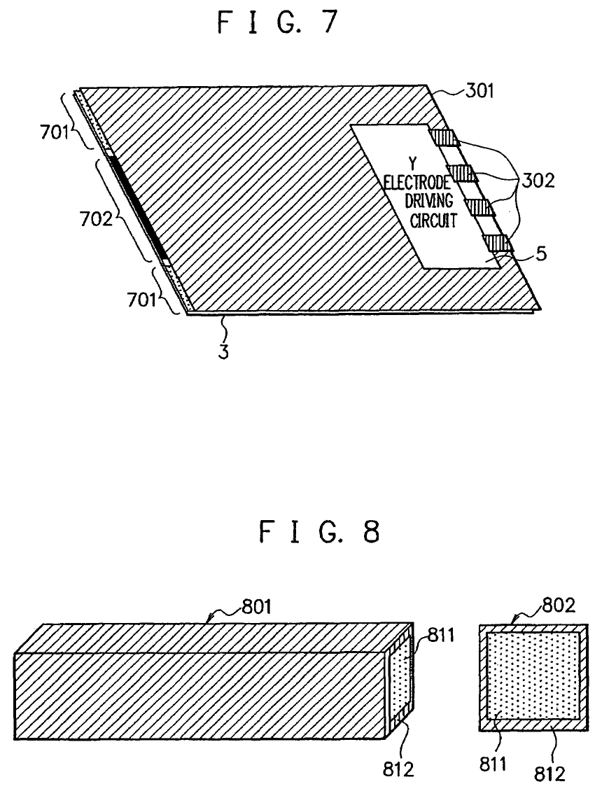

FIG. 7 is a perspective view showing a structural example of the plasma display device according to a sixth embodiment of the present invention. The present embodiment is basically the same as the first embodiment (FIG. 3). The end portion of the X electrode Xi on the front glass substrate 1 is connected to the chassis 301 via a conductor 701 as a fixed potential at a ground level. The central portion of the X electrode Xi on the front glass substrate 1 is connected to the chassis 301 via a conductor 702 as a fixed potential at a ground level. The conductor 701 connected to the X electrode Xi at the end portion and the conductor 702 connected to the X electrode Xi at the central portion differ from each other in specific resistance. It is possible to control brightness difference or the like by making the whole impedance of the plasma display panel 3 equal, by, for instance, lowering the specific resistance of the conductor 701 at the end portion of the panel and increasing the specific resistance of the conductor 702 at the central portion of the panel. In short, since the length of the electrode wiring at the central portion of the panel is short, the impedance is low, and since the length of the electrode wiring at the end portion of the panel is long, the impedance is high. Accordingly, by making the specific resistance of the conductor 701 at the end portion of the panel low, and the specific resistance of the conductor 702 at the central portion of the panel high, impedance of the whole lines can be made equal, thereby making the brightness of all lines equal.

As described above, according to the present embodiment, the conductor at portions 701 connected to end portions and at portions 702 connected at central portions among a plurality of the X electrodes Xi are made different in specific resistance. The conductor may gradually change its specific resistance from a portion connected with the end portion to a portion connected with the central portion.

Other points are the same as in the first embodiment (FIG. 3). A plurality of the Y electrodes Yi are connected to the Y electrode driving circuit 5 via the FPC 302. A ground of the Y electrode driving circuit 5 is connected to the chassis 301.

### Seventh Embodiment

FIG. 8 is a view showing a structural example of the conductor according to the seventh embodiment of the present invention. The conductor in the present embodiment can be used for the conductor used in the plasma display device according to other embodiments of the present invention. A conductor 801 is shown in a perspective view, and a conductor 802 is shown by a cross section of the conductor 801. Conductivity is given to the conductor, for instance, by winding a copper foil 812 or the like around resin 811 such as rubber. In short, the conductor is rubber having a conductive layer around its periphery. Elasticity can be given by using the resin 811. It is needless to say that a conductive rubber can be applied as conductor having elasticity. In addition to that, metal to which a conductor having elasticity is provided on the X electrode side, can also be used. Thus, by having a conductor carry elasticity, it becomes possible to absorb difference in thermal expansion between a plasma display panel and a chassis. Thereby, it becomes possible to prevent cracking of the plasma display panel or detaching of connection between the plasma display panel and the chassis.

### Eighth Embodiment

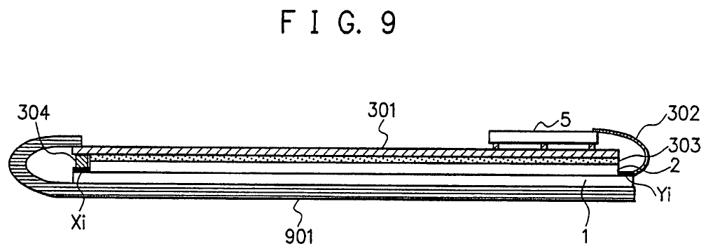

FIG. 9 is a view showing a structural example of the plasma display device according to the eighth embodiment of the present embodiment. The present embodiment is carried out while adding a front filter 901 to the first embodiment (FIG. 3). The front filter 901 covers the front of the plasma display panel 3 (the front glass substrate 1 and the back glass substrate 2) to shield electromagnetic waves generated from the plasma display device. It is possible to directly connect the front filter 901 with a chassis without through a back cover by extending an end of the front filter 901 longer than an end of the plasma display panel 3, and by bending the extended portion. Other points are the same as those in the first embodiment (FIG. 3).

### Ninth Embodiment

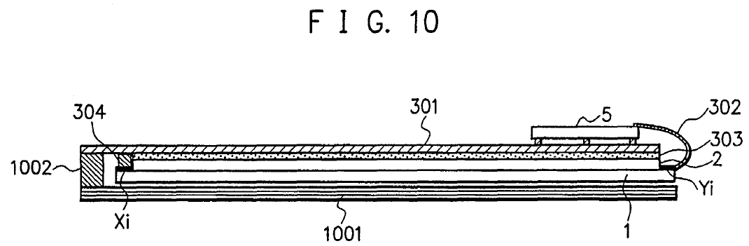

FIG. 10 is a view showing a structural example of the plasma display device according to the ninth embodiment of the present invention. The present embodiment is carried out while providing a front filter 1001 instead of the front filter 901 in the eighth embodiment (FIG. 9). The front filter 1001 covers the front of the plasma display panel (the front glass substrate 1 and the back glass substrate 2) 3 to shield electromagnetic waves generated from the plasma display device. In the present embodiment, the front filter 1001 is connected to the chassis 301 via a conductor 1002. When the plasma display device has a structure such that the front filter 1001 cannot be bent, or when some inconvenience happens by bending the front filter 1001, it is possible to connect the front filter 1001 with the chassis 301 via the conductor 1002. The front filter 1001 can be made flat without being bent. In that event, it doesn't matter whether the front filter 1001 be in contact with the plasma display device 3, or not.

As described above, according to the first to ninth embodiments, the X electrode driving circuit 4 in FIG. 14 is made unnecessary, and by connecting the X electrode driving circuit 4 with the chassis 301 without using the FPC 1401, it becomes possible to realize the cost reduction. In addition, since the X electrode Xi can be connected with the chassis 301 at a short distance without through the X electrode driving circuit 4 and the FPC 1401, it becomes possible to realize lowering of the impedance therebetween, and the ground potential can be kept fixed. The chassis 301 could have a potential, not only exact ground potential but also other constant potential as far as it is in a working range. Additionally, the chassis 301 could have other structure, not only the structure shown in the figures but also other various structure as far as it supports plasma display panel.

The present embodiments makes it unnecessary to provide a first electrode driving circuit, and possible to reduce costs by connecting the first electrode and the chassis without using the FPC. In addition to that, since the first electrodes can be connected to the chassis in a short distance, the impedance therebetween can be lowered and the ground potential can be kept fixed.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display device, comprising:
a first substrate and a second substrate opposed to each other;
a first electrode and a second electrode arranged in parallel on one of the first and second substrates so as to enable generation of a display discharge therebetween; and
a chassis which supports at least one of the first and second substrates;
wherein the first electrode is connected to the chassis without interposition of a circuit for controlling the first electrode and is maintained at a constant potential.

2. A plasma display device according to claim 1,
wherein the first electrode is directly connected to the chassis, so as to enable a reduced impedance in a path between the first electrode and the chassis.

3. A plasma display device according to claim 1, further comprising:
an electrode driving circuit applying a discharge voltage to the second electrode;
wherein the second electrode is connected to the chassis via the electrode driving circuit, and the first electrode is directly connected to the chassis.

4. A plasma display device according to claim 1,
wherein the first electrode is connected to the chassis without interposition of a circuit so as to maintain a voltage applied to the first electrode at a constant potential.

5. A plasma display device according to claim 1,
wherein the constant potential is a ground potential.

6. A plasma display device according to claim 4,
wherein the constant potential is a ground potential.

7. A surface discharge type AC color plasma display device, comprising:
a front substrate and a rear substrate opposed to each other;
a scan electrode and a sustain electrode arranged in parallel on the front substrate, and extending in a first direction;
an address electrode arranged on the rear substrate, and extending in a second direction perpendicular to the first direction;
an address electrode driving circuit applying a voltage to the address electrode;
a scan electrode driving circuit applying a voltage to the scan electrode; and
a chassis supporting at least the rear substrate;
wherein the scan electrode is connected to the chassis via the scan electrode driving circuit to apply a discharge voltage to the scan electrode, and the sustain electrode is connected to the chassis without interposition of a circuit to control a voltage applied to the sustain electrode, and the sustain electrode is maintained at a constant potential.

8. A plasma display device according to claim 7,
wherein the constant potential is a ground potential.

9. A plasma display device, comprising:
a first substrate and a second substrate opposed to each other;
a first electrode and a second electrode arranged in parallel on one of the first and second substrates so as to enable a generation of a display discharge therebetween; and
a chassis which supports at least one of the first and second substrates;
wherein the first electrode is connected to the chassis via a conductor and is maintained at a constant potential; and
wherein the conductor is sandwiched between the first substrate and the chassis.

10. A plasma display device according to claim 9,
wherein the first electrode is connected to the chassis without interposition of a circuit for controlling the first electrode and is maintained at a constant potential.

11. A plasma display device according to claim 9, further comprising:
an electrode driving circuit applying a discharge voltage to the second electrode;
wherein the second electrode is connected to the chassis via the electrode driving circuit.

12. A plasma display device according to claim 10,
wherein the first electrode is connected to the chassis without interposition of a circuit to maintain a voltage applied to the first electrode at a constant potential.

13. A plasma display device according to claim 12,
wherein the constant potential is a ground potential.

14. A plasma display device according to claim 12,
wherein the second substrate is arranged between the first substrate and the chassis; and
an end portion of the chassis is extended beyond an end of the second substrate so as to connect with the first electrode on the first substrate.

15. A plasma display device according to claim 9,
wherein the second substrate is arranged between the first substrate and the chassis; and
an end portion of the chassis is bent in the direction of the first substrate so as to connect with the first electrode on the first substrate.

16. A plasma display device according to claim 9,
wherein the first electrode and the conductor are connected with a conductive adhesive member.

17. A plasma display device according to claim 9,
wherein the conductor and the chassis are connected with a conductive adhesive member.

18. A plasma display device according to claim 9, wherein conductor is connected to the chassis by a screw.

19. A plasma display device according to claim 9,
wherein the conductor is an elastic member.

20. A plasma display device according to claim 19,
wherein the conductor is a conductive rubber member.

21. A plasma display device according to claim 19,
wherein the conductor is a rubber member surrounded by a conductive film.

22. A plasma display device according to claim 19,
wherein the conductor is a metal having elasticity at least in a portion connected to the first electrode side.

23. A plasma display device according to claim 9, further comprising:
a filter arranged in front of the first substrate so as to shield electromagnetic waves,
wherein the filter is directly connected to the chassis.

24. A plasma display device according to claim 9, further comprising:
a filter arranged in front of the first substrate so as to shield electromagnetic waves,
wherein the filter is connected to the chassis via the conductor.
